(19) United States
(12) Patent Application Publication
(10) Pub. No.: US 2010/0020435 A1
(43) Pub. Date: Jan. 28, 2010

(54) RECORDING DEVICE WITH WRITE HEAD SPANNING MULTIPLE ROWS OF BIT CELLS AND MULTI-SENSOR READ HEAD

(75) Inventors: YunJie Chen, Singapore (SG); Zhimin Yuan, Singapore (SG); Siang Huei Leong, Singapore (SG); Ka Wei Ng, Singapore (SG); Bo Liu, Singapore (SG)

Correspondence Address: DINSMORE & SHOHL LLP, FIFTH THIRD CENTER, ONE SOUTH MAIN STREET, SUITE 1300, DAYTON, OH, 45402-2023, US

(73) Assignee: AGENCY FOR SCIENCE, TECHNOLOGY AND RESEARCH, Singapore (SG)

(21) Appl. No.: 12/507,881

(22) Filed: Jul. 23, 2009

Related U.S. Application Data
(60) Provisional application No. 61/129,877, filed on Jul. 25, 2008.

(51) Int. Cl. G11B 5/596

(52) U.S. Cl. 360/77.02; G9B/5.216

(57) ABSTRACT

In a recording device, a bit patterned medium comprises a track of bit cells, each settable to one of two distinct bit states. The track comprises two generally parallel rows of bit cells. The bit cells in one row are offset in a down track direction from the bit cells in the other row. A write head spans the two rows. A controller synchronously applies write signals to the write head to set the trailing bit cell covered by the write head as the track moves relative to the write head, and thereby write data to the track. The trailing bit cell covered by the write head alternates from being in one row to being in another row. Read sensors are positioned to independently read bit cells in respective rows, as the track moves relative to the write head along the down track direction.

### CROSS-REFERENCE TO RELATED APPLICATION

This application claims the benefit of U.S. provisional application No. 61/129,877, filed Jul. 25, 2008, the entire contents of which are incorporated herein by reference.

### FIELD OF THE INVENTION

The present invention relates generally to data storage media and devices, and more specifically to bit patterned media and methods and devices for writing to and reading from such media.

### BACKGROUND OF THE INVENTION

Bit patterned media such as discrete bit patterned media have gained more and more attention as a suitable medium for recording data. A bit patterned media typically has a recording surface on which the recording cells are regular spaced and each cell may store one bit of data. For example, a typical arrangement is to align the cells along a track. Data is written or read by moving the track and a write or read head relative to each other along the direction of the track across the cells. A recording device may include a number of tracks, which are typically arranged in parallel. The parallel tracks may be linear or concentric.

One magnetic recording technique provides a bit patterned medium having a “super track.” The super track includes a plurality of sub-tracks, on which discrete bit cells are formed. The tracks form concentric circles with different radii. The bit cells on adjacent sub-tracks are arranged at different positions in a circumferential direction. The reading head for reading data recorded on the bit patterned medium has a width in a cross-track direction sufficient for reading data of an equal number of bit cells as the plurality of sub-tracks. It is said that this technique can increase reading efficiency.

In another magnetic recording technique, complementarily magnetically poled regions are simultaneously written in adjacent positions in two parallel tracks. A magnetic sensor is exposed to the combined flux from both tracks. This technique is said to provide a high degree of data redundancy in the event of small physical anomalies in the magnetic medium or writing anomalies in one track or the other, and allow higher data density.

### SUMMARY OF THE INVENTION

In accordance with an aspect of the present invention, there is provided a method of recording and reading data. The method comprises providing a bit patterned medium comprising at least one track of bit cells, each of the bit cells settable to one of two distinct bit states, the track comprising at least two generally parallel rows of the bit cells, with bit cells in one of the two rows offset in a down track direction from bit cells in the other of the two rows, positioning a write head over the track of bit cells, the write head spanning the two rows; moving the track relative to the write head along the down track direction; synchronously applying write signals to the write head to set the trailing bit cell covered by the write head, wherein the trailing bit cell covered by the write head alternates from being in one of the at least two rows to being in another of the least two rows as the track moves relative to the write head along the down track direction, and thereby write data to the track; positioning a first read sensor over bit cells in one of the two rows and a second read sensor over bit cells in the other of the two rows to independently read the bit cells in the two rows as the track moves relative to the write head along the down track direction. The bit patterned medium may be a discrete bit patterned medium. The bit patterned medium may comprise bit cells forming a generally hexagonally close packed pattern. The rows of bit cells may be generally concentric, or generally linear. The track may have two rows of bit cells. The track may have more than two rows of bit cells and the method may comprise positioning more than two read sensors to independently read bit cells in more than two rows. The medium may comprise a plurality of tracks. The write head may simultaneously cover one or a plurality of bit cells. A synchronization clock signal may be generated from a read signal sensed by at least one of the read sensors. The application of the write signal may be synchronized based on the synchronization clock signal. A position error signal may be generated from a read signal sensed by at least one of the read sensors, which is indicative of a position of the write head relative to the track in a cross track direction. The positioning of the write head in the cross track direction may be corrected based on the position error signal.

According to another aspect of the present invention, there is provided a recording device. The recording device comprises a bit patterned medium comprising at least one track of bit cells, each of the bit cells settable to one of two distinct bit states, the track comprising at least two generally parallel rows of the bit cells, with bit cells in one of the two rows offset in a down track direction from bit cells in the other of the two rows; a write head spanning the two rows of the bit cells; a controller for synchronously applying write signals to the write head to set the trailing bit cell covered by the write head as the track moves relative to the write head, wherein the trailing bit cell covered by the write head alternates from being in one of the at least two rows to being in another of the at least two rows, and thereby write data to the track; first and second read sensors each positioned to independently read bit cells in a respective one of the two rows, as the track moves relative to the write head along the down track direction. The bit patterned medium may be a discrete bit patterned medium. The bit patterned medium may comprise bit cells forming a generally hexagonally close packed pattern. The rows of bit cells may be generally concentric, or generally linear. The track may have two rows of bit cells. The track may have more than two rows of bit cells and the recording device may comprise more than two read sensors each for reading bit cells in one of the rows. The medium may comprise a plurality of tracks. The write head may be configured and sized to simultaneously cover one or a plurality of bit cells. The recording device may further comprise a processor for generating a synchronization clock signal from a read signal sensed by at least one of the read sensors. The controller may synchronize application of the write signals to the write head based on the synchronization clock signal. The recording device may further comprise a processor for generating a position error signal from a read signal sensed by at least one of the read sensors. The position error signal is indicative of a position of the write head relative to the track in a cross track direction. The controller may correct positioning of the write head in the cross track direction based on the position error signal.

Other aspects, features and benefits of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic view of a data storage device;

FIG. 2 is a schematic view of a write/read head and a discrete bit patterned medium in a data storage device;

FIGS. 3, 4, 5 are schematic diagrams showing the write operation of the write head of FIG. 2;

FIG. 6 is a schematic diagram showing the write operation of the write/read head of FIG. 2;

FIG. 7 is a schematic diagram showing the read operation of the write/read head of FIG. 2;

FIG. 8 is a schematic diagram showing the dependence of a read signal on read sensor's cross-track position;

FIG. 9 is a schematic diagram of an exemplary construction of the read head of FIG. 2;

FIG. 10 is a schematic diagram of an exemplary construction of an alternative read head structure; and

FIG. 11 is a schematic diagram of the alternative read head structure of FIG. 10 in operation.

### DETAILED DESCRIPTION

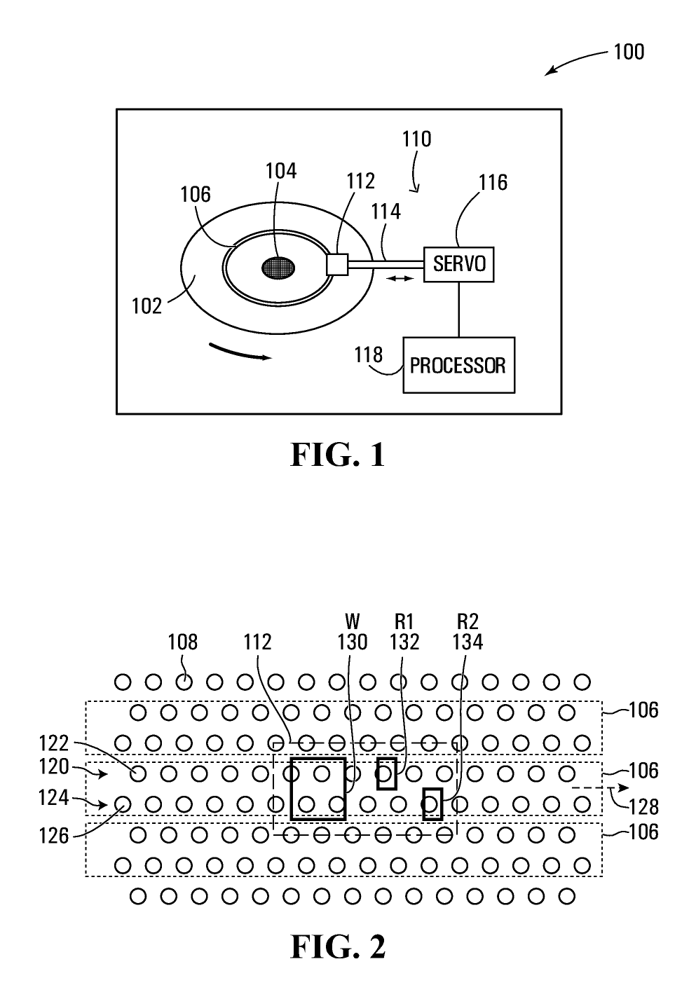

An exemplary embodiment of the present invention relates to a magnetic recording device 100 schematically illustrated in FIGS. 1 and 2. Device 100 includes a disc 102, which is received by a housing 104 (only partially shown in FIG. 1). Housing 104 may include a spindle (not separately shown) for supporting and rotating disc 102 around a central axis. Disc 102 contains a discrete bit patterned medium (DBPM) on which a plurality of concentric tracks 106 of bit cells 108 are formed (for simplicity, only one track 106 is depicted in FIG. 1).

Each bit cell is an isolated island for storing one bit of data and can be set in either of two alternative, distinct bit states, which may be represented by “0” and “1”, or “” and “x”. The two alternative bit states may correspond to two different magnetic, electrical, optical, or other physical or chemical states of the cell. For example, the two bit states may correspond to two different magnetic states which may be set by applying an external magnetic field in two different directions.

Device 100 also includes a combined writer/reader 110, which has a moveable (write/read) head 112. Head 112 is mounted on a support 114, which is driven by a motor or servo 116 for moving head 112 to different radial positions to write/read different tracks 106. Head 112 is connected to a controller 118 for applying write signals and processing read signals. Controller 118 may be connected to the spindle and servo 116, for controlling or monitoring the rotation of disc 102 and the lateral movement of head 112, and for synchronizing the write/read signals with movements of disc 102 and head 112.

While tracks 106 of disc 102 are concentric, for simplicity, tracks 106 are shown as generally linear in FIG. 2. In other embodiments, the tracks may be arranged linearly on a patterned medium. For linear tracks the mechanism for repositioning write/read head over the bit cells may need to be modified, as can be understood by those of skill in the art. In further embodiments, tracks may be shaped and arranged in other patterns. Regardless of whether the tracks are linear or concentric, they may be arranged generally parallel to one another, as exemplified in FIG. 2.

As depicted in FIG. 2, cells 108 may be regularly and uniformly distributed across the surface of the bit patterned medium. Cells 108 in a track 106 are arranged in rows 120 and 124. Each track 106 is formed of a first row 120 of cells 122 and a second row 124 of cells 126. A direction along the track 106 is referred to as the down-track direction, as indicated by the arrow 128 in FIG. 2. This is the direction in which cells 122 and 126 in the track 106 will be sequentially accessed. The direction in the medium surface that is perpendicular to the down-track direction is referred to as the cross-track direction.

Cells 122, 126 in the rows 120, 124 in a track 106 are offset (spaced apart) in the down track direction. As depicted in FIG. 2, cells 122, 126 are interleaved along the down-track direction. That is, if a side elevation view is taken in the cross-track direction, cells 122, 126 from rows 120, 124 alternately appear.

As used herein, the cell-to-cell distance in a down-track direction refers to the distance between the centers of a pair of adjacent cells 108 in the same row. The row-to-row distance refers to the distance between the two lines that respectively pass through the centers of cells in two adjacent rows, such as rows 120 and 124. The size of cells 108 may be substantially uniform. As can be appreciated, the cell density in a given DBPM is limited by the available fabrication technique and cannot be infinitely increased. The smallest practical cell-to-cell distance in a DBPM is thus also limited.

To access cells 108 in a given track 106, track 106 is moved relative to head 112 in the down-track direction. To access cells 108 in a different track 106, head 112 is moved relative to the tracks 106 in the cross-track direction. For example, to access cells 108 in a particular track 106, head 112 is positioned to cover that particular track 106 by moving head 112 in a cross-track direction with servo 116 and support 114. Once moved to the appropriate position, head 112 is held in a fixed position relative to housing 104, and disc 102 is rotated to move the track 106 relative to head 112 so that different cells 108 are sequentially covered by head 112, and thereby can be accessed (written or read) by head 112 in sequence. It should be understood that in different embodiments a track may be moved relative to a write/read head by actuating either the track or the head, or both. For example, a track 106 may also be moved relative to head 112 by moving head 112 relative to housing 104 while holding disc 102 in position relative to housing 104. In some embodiments, as depicted in FIG. 1, it may be convenient to rotate disc 102 to actuate the track 106, while holding head 112 in a fixed position relative to housing 104. In any event, the relative movement between track 106 and head 112 repositions cells 108 in the track 106 relative to head 112 so that head 112 sequentially covers cells 108 in the track 106 along the down track direction.

Head 112 has a write head 130 for applying a pulsed write signal to set the bit states of the individual cells 108. Write head 130 has a width (in the cross-track direction) sufficient to span at least two rows 120, 124 of cells 122, 126, to cover multiple cells 122, 126 including a trailing bit cell in the at least two rows 120, 124. As depicted in FIG. 2, write head 130 spans two rows and covers three full cells. When a cell 108 is covered by write head 130, application of a write signal by write head 130 will set or reset the bit state of that cell 108. As can be readily understood by those skilled in the art, the area in which the write signal is strong enough to set the bit cells in the area may be dependent on the physical shape and size of write head 130, the strength of the signal and possibly other factors. Thus, this area may be larger or smaller than the physical size of the write head 130. As long as a cell 108 is within this area, it is considered to be covered by the write head 130. On the one hand, in some embodiments it may not be necessary for the entire cell 108 to be physically under the write head 130 to be covered by the write head 130. On the other hand, in some other embodiments, a cell 108 positioned entirely under write head 130 but close to an edge may not be covered by write head 130 in the sense that a pulse of the write signal applied through the write head 130 does not reset the bit state in that cell at that position.

As write head 130 is configured and positioned to simultaneously cover a number of cells, the application of one pulse of the write signal will set the bit states in the cells covered by the write head 130. As depicted in FIG. 2, when a pulse of the write signal is applied when write head 130 is at the position shown, the bit states of one cell 122 in row 120 and two cells 126 in row 124 are set at the same time.

As can be understood from FIG. 2, due to the offset between cells 122, 126 in the down track direction, at any given position when a pulse of write signal is applied, one of the cells 122, 126 covered by write head 130 is the trailing bit cell, in the sense that it is the last covered cell along the down track direction and will not be covered by write head 130 after the track 106 has moved relative to write head 130 along the down track direction to write the next cell.

In different embodiments, the bit cells may be arranged differently and the write head may be configured differently, such as with different shapes and sizes, to ensure that there is a single trailing bit cell covered by the write head at each position when a pulse of the write signal is applied. For example, the write head construction may be similar to those used in a typical hard drive currently available from commercial sources.

In one embodiment, the bit cells may have a cell-to-cell distance of about 25 nm in either down track or cross track direction and may have a cell density of about 1,000 Gbit/in². When each track has two rows of cells, the effective bit cell size may be about 12.5 nm long in the down track direction (thus providing a down track bit density of 2,000 kbpi) and about 50 nm wide in the cross track direction (thus providing a track density of 500 ktpi). In this case, the write head may be about 50 nm in width and about 50 nm to 100 nm in length.

Head 112 also functions as a read head and has a first read sensor 132 for reading (sensing a read signal from) cells 122 in row 120 and a second read sensor 134 for reading (sensing a read signal from) cells 126 in row 124. Read sensors 132 and 134 may be mounted in fixed spatial relation with respect to write head 130. In the embodiment shown in FIG. 2, read sensors 132 and 134 are distant from one another in the down track direction. The down-track distance between read sensors 132 and 134 may be greater than the down-track cell-to-cell distance. The size of each of read sensors 132 and 134 may be selected to optimize the read signal and to reduce signal interference from adjacent cells. In some embodiments, the down-track distance between read sensors 132 and 134 may be from about 50 nm to about 10 um, such as from about 50 nm to about 1 um.

Sensors 132 and 134 may be magnetoresistance (MR) sensors such as giant magnetoresistance (GMR) sensors. Sensors 132 and 134 are each positioned during use to independently read bit cells in a respective row 120 or 124, as track 106 moves relative to head 112 along the down track direction.

Controller 118 may be separately provided or incorporated into head 112. Controller 118 is adapted to synchronously apply write signals to write head 130 to set the trailing bit cell covered by the write head 130 as a track 106 moves relative to write head 130 along the down track direction and the trailing bit cell alternates from in one of rows 120,124 to another of rows 120,124, and thereby write data to the track 106. Controller 118 may also include a processor or circuit for processing signals received from read sensors 132 and 134 to generate a read signal for the track that is being read, and optionally other output signals. For example, controller 118 may include a component (not shown in FIG. 1) for combining the sensed signals from sensors 132 and 134, a component (not shown in FIG. 1) for extracting a timing (clock) signal, a synchronization signal, or a position error signal from one or both of the sensed signals.

During use, cells 122 and 126 can be individually written to store data using write head 130. While each pulse of the write signal sets the bit states of a plurality of cells 108 in track 106, each cell 122 or 126 may store a data bit independent of the data bits stored in adjacent cells. This is because the down track distance between cells 108 is sufficiently large and write head 130 is suitably configured and shaped so that after application of a pulse of the write signal and the track 106 has been moved relative to write head 130 along the down track direction to the next write position, the last trailing bit cell 122 or 126 is no longer covered by write head 130 and a new bit cell in another row becomes the next trailing bit cell. Thus, the bit state of the next trailing bit cell can be set without resetting the bit state of the last trailing bit cell.

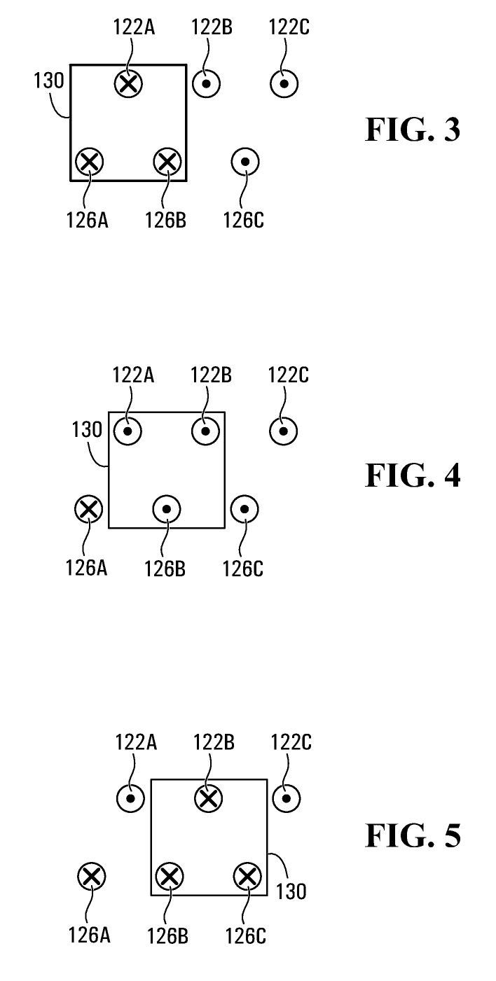

An exemplary write process is illustrated in FIGS. 3, 4, and 5. For illustration purposes, the followings are assumed. The down track direction is from left to right and write head 130 moves relative to cells 122A, 122B, 122C, 126A, 126B, 126C from left to right, as depicted in FIGS. 3, 4, and 5. All cells 122A, 122B, 122C, 126A, 126B, 126C are initially set to a positive state (denoted by the dots), and each write signal pulse sets the states of three cells when write head 130 is properly positioned over the track 106 in a cross-track direction. Depending on the polarity of the pulse that is applied, the cell that is being written will have either a “1” or a “0” bit state. Each of Cells 122 and 126 stores a binary bit as depicted, wherein “x” represents “1” (and can be set by application of a negative pulse) and “” represents “0” (and can be set by application of a positive pulse).

When write head 130 is at the position shown in FIG. 3 in the down track direction, a negative pulse is applied, which sets each of cells 126A, 122A, 126B to a negative state (or “1” bit state). The trailing bit cell is 126A in row 124 at this position. The bit states of cells 126C, 122B, 122C are unaffected by this pulse.

The write head 130 is next at the position shown in FIG. 4 in the down track direction, and a positive pulse is applied. Cell 122A in row 120 is now the current trailing bit cell. The positive pulse resets each of cells 122A, 126B, 122B to a positive state (or “0” bit state), as shown. However, due to sufficient separation along the down track direction between cells 122A and 126A, the positive pulse can be applied without resetting the bit state of the last trailing bit cell, cell 126A, which remains in the “1” (“x”) bit state as shown. As can be seen, the bit states of cells 126C, 122C are also not reset by this pulse.

The write head 130 is next at the position shown in FIG. 5 in the down track direction, and a negative pulse is applied. Cell 126B in row 124 is now the current trailing bit cell. The negative pulse resets each of cells 126B, 122B, 126C, to a negative state (or “1” bit state), as shown, without resetting the bit states of the previous trailing bit cells, cell 122A or 126A. The states of cells 122A and 126A thus remain unchanged.

As now can be appreciated, this process can be repeated to further set the individual bit states in the other down track cells 122B, 126C, 122C respectively. As can be seen in FIGS. 3 to 5, the trailing bit cell covered by write head 130 alternates from being in row 120 to being in row 124.

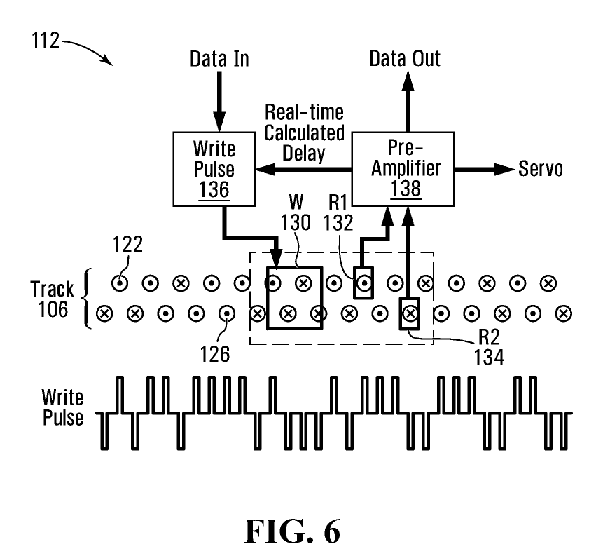

The exemplary write/read process is further illustrated in FIG. 6. As shown, input data may be fed to write head 130 as pulse signals generated in a write pulse generator 136. As the track 106 moves relative to write head 130 along the down-track direction, cells 122 in row 120 and cells 126 in row 124 are alternately written, as cells 122 and 126 are offset and interleaved in the down-track direction.

Effectively, the down-track write resolution and data rate have been doubled, as compared to a one-row-per-track configuration, without reducing the down-track cell-to-cell distance. Although this arrangement may require higher positioning accuracy for write head 130, the position synchronization of write head 130 can be improved using the read signals sensed by the read sensors 132, 134, as will become apparent from the description below.

As illustrated in FIG. 6, during operation, read sensors 132, 134 are placed ahead of write head 130 and can send sensed cell signal synchronized with clock signal to a pre-amplifier 138, which in turn sends amplified timing and synchronization information to write pulse generator 136, so that the write pulse can be synchronized with the relative movement between track 106 and write head 130 to reduce position errors. As the combined read signals have an increased down-track read resolution (see below), the synchronization of write signal can be consequently improved. Specifically, during the write process, the clock (timing) signals extracted from read sensors 132, 134 may be continuously input to a timing circuit (e.g. pulse generator 136) through pre-amplifier 138 and compared, to provide an appropriate delay time for the next write pulse, thus synchronizing the write pulses with the write head movement/position. For example, if a read sensor 132 or 134 detects a read signal from a particular cell where the read signal has a peak at a time later than the expected peak time, which may be caused by, e.g., a decreased rotation rate of disc 102, a timing error can be sent to the timing circuit. The delay in time is calculated and the application of the subsequent write pulses can be delayed by the calculated delay time. If the detected read signal peak is ahead of the expected peak time, the application of the subsequent write pulses may be moved forward in time. In this regard, the read signal from a single read sensor may be sufficient to provide the timing information. However, the read signals from multiple read sensors may be used to provide more accurate and more reliable timing information. For example, two delay times may be obtained from two separate read signals and the average of the delay times may provide a more accurate delay time. When both signals provide the same or similar delay time, it is less likely the apparent delay in time is an artifact.

As illustrated above, an exemplary process for recording and read data may performed as follows. A bit patterned medium having one or more tracks of bit cells as described herein is provided. A write head is positioned over a track of bit cells, and spans at least two rows of the track to cover a plurality of bit cells in these rows. The covered bit cells include a single trailing bit cell. The track is moved relative to the write head along the down track direction to sequentially cover the bit cells in the track with the write head, with the trailing bit cell alternating from in one row to another row in the track. Write signals are synchronously applied to the write head to set the trailing bit cell covered by the write head, and thereby write data to the track. Two read sensors are positioned over bit cells in two of the rows in the track to independently read bit cells in the two rows as the track moves relative to the write head along the down track direction. The read signals may be used to extract timing and position signal to improve write/read head positioning and signal synchronization.

Conveniently, increased down-track write resolution and data rate can be obtained for a given down-track cell density. As can be appreciated, the down-track cell density in DBPM is limited by the available lithography technology. However, with device 100 the down-track data resolution can be higher than the down-track cell resolution. With increased number of rows in a single track, the down-track data resolution may be further increased.

Further, when write head 130 is larger than a write head sized for writing to a single cell, the fabrication of write head 130 may be simple. With a larger size, a stronger writing field may be applied. The bit aspect ratio (BAR) can also be conveniently adjusted by increasing the cross-track distance between two adjacent tracks.

As compared with a single-row per track patterned medium where the bit cells are arranged in a cubic lattice pattern, the medium pattern shown in FIG. 2 (with a hexagon-close-packed (HCP) lattice pattern) provides an increase in cell density by about 16%, with the same minimum cell-to-cell down-track distance.

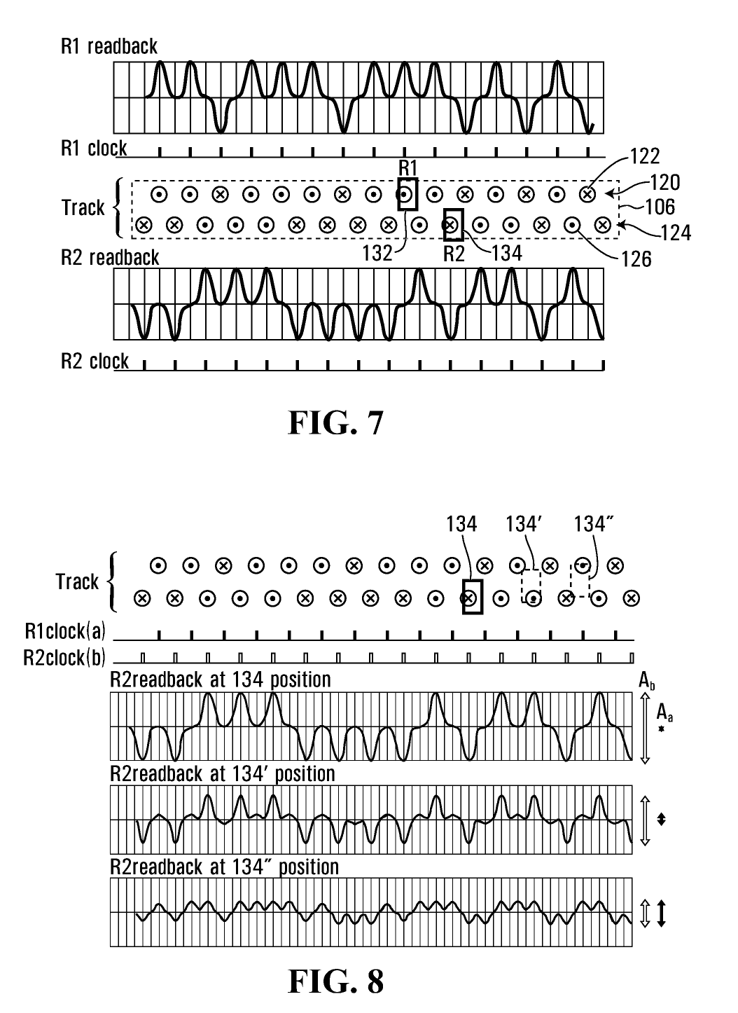

FIG. 7 illustrates the read operation. As track 106 moves relative to head 112 along the down track direction, read signals indicative of the bit states of the cells 122, 126 in rows 120, 124 are detected by read sensors 132, 134 respectively. As shown in FIG. 7, the read signal from the first read sensor 132 is indicated as “R1 readback”, and the second read signal from the second read sensor 134 is indicated as “R2 readback”. The readback signals are synchronized with clock signals (indicated as “R1 clock” for read sensor 132 and “R2 clock” for read sensor 134). The timing of each signal pulse is correlated to the position of the respective read sensor 132, 134, and thus the cell that has been read. Because cells 122 in row 120 are interleaved with cells 126 in row 124 in the down-track direction, the pulses in R1 readback signal and R2 readback signal are also interleaved in time.

The readback signals may be converted to digital signals using a conventional analog-to-digital conversion technique to extract the digital signals representing the binary bit states of the cells. To this end, readback signals R1 and R2 may be separately converted and the resulting digital signals may be separately processed to map out the bit states of the cells 108. Alternatively, either the digital signals or the analog signals may be combined (such as interleaved) and then processed to extract the bit states for the individual cells 108. Depending on the particular embodiment and the application, different decoding algorithms for extracting and mapping the cell states may be readily developed by those skilled in the art.

Conveniently, with two read sensors each reading one of the rows of cells in a track, the combined down-track read resolution is increased (doubled) without having to reduce the down-track cell-to-cell distance.

The read signals, either separately or combined, can also be conveniently processed to extract and provide other useful information. For example, the read signals can provide timing information for write synchronization, such as described above.

In addition, the read signals can also be used to generate a position error signal (PES) that is indicative of the position of the write/read head in the cross track direction relative to the current track. The PES can be used to correct misalignment of the head relative to the track in the cross track direction to keep the head properly aligned with the track. A PES can be extracted from R1 or R2 readback signal or a combination of the two signals. With the PES, it is not necessary to implement additional cross track position detecting techniques, such as adding servo burst patterns which are commonly used in conventional hard drives.

An exemplary process for generating a PES is illustrated in FIG. 8. Assuming due to servo inaccuracy, the cross-track position of head 112, and thus those of write head 130 and read sensors 132, 134, may vary during reading track 106. Three possible cross-track positions for read sensor 134 are shown in FIG. 8, indicated as 134 at position X, 134′ at position Y, and 134″ at position Z. Generally, the amplitude A(p) of the overall read signal detected by read sensor 134 at position “p” in the cross track direction may be denoted as A(p)=Aₐ(P)+A_{b}(P), where Aₐ and A_{b} represent the contributions from different cells that are detected by read sensor 134 at any particular position. In FIG. 8, it is assumed that Aₐ(p)=A₁₂₆(p) and A_{b}(P)=A₁₂₆ (p), where A₁₂₂(p) and A₁₂₆ (p) represent the detected signal amplitude from cell 122 or 126 respectively by read sensor 134 at position “p”. For illustration purposes, it is also assumed the read signals from the cells in the two rows are of the same maximum amplitude. In one embodiment, PES may be defined as PES(p)=[A₁₂₂(p)—A₁₂₆ (p)]/[A₁₂₂(p)+A₁₂₆ (p)]. The signal peaks in the read signal may be correlated with the respective cells based on the timing of the peaks. Further, the read signals may be decoupled into separate waveforms each from one row of the cells, and the waveforms may be correlated with the respective rows based on the phases of the waveforms, as can be understood by those skilled in the art.

Read sensor 134 is generally aligned with centers of cells 126 and is considered at the “on-track” position. Assuming this position is denoted as p=p₀, as indicated in FIG. 8, at this position, Aₐ=A₁₂₆(p₀) is at the maximum and A_{b}=A₁₂₂(p₀) is small. It follows that A₁₂₂(p₀)<<A₁₂₆ (p₀). Thus, PES(p₀)≈1.

Read sensor 134′ is partially “off-track” at the position denoted as p=p₁. A(p₁) contains a reduced contribution from cell 126 and an increased contribution from cell 122, but A_{b}=A₁₂₂(p) is still smaller than Aₐ=A₁₂₆ (p₁), as illustrated. Thus, 0<PES(p₁)<1.

Read sensor 134″ is at a position half-way between the two rows in the cross-track direction (denoted as p=p₂). At this position, A₁₂₂(p₂)=A₁₂₆ (p₂). Thus, PES(p₂)=0.

PES(p) can therefore be monitored in real time and used as feedback for tracking head position and for servo control to correct any misalignment. A PES can be generated from any read sensor, or from a combination of multiple read sensors. The PES generated from multiple read sensors may be more accurate and more reliable than a PES generated from a single read sensor.

The different signal profiles of the read signal from read sensor 134 at different down track positions are also shown in FIG. 8.

As can now be appreciated, in device 100 down track recording resolution may be higher than the patterning resolution, which leads to both higher linear data density and higher data rate. Overall data density is also higher as compared to a normal cubic packed patterned medium. The BAR may be conveniently adjusted. The requirement for servo or motor mechanism may be relaxed. Write synchronization may be improved and error rate may be reduced. With more than one read sensor, the down track read resolution is also increased; and real-time, accurate monitoring and adjustment of bit clock information for write synchronization may be obtained. Read signals may be used to generate a PES signal, thus reducing or eliminating the need for servo bursts, which in turn can result in reduced servo wedge area and increased data storage efficiency.

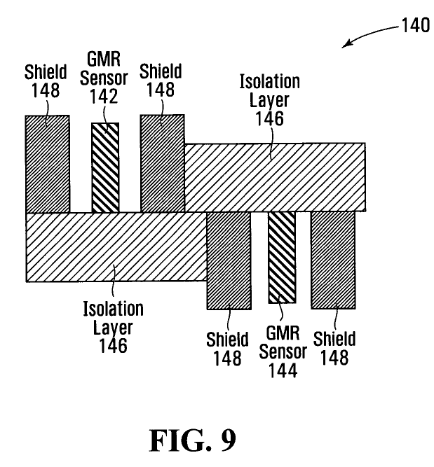

FIG. 9 shows an exemplary construction of the read head 140 in head 112. Read head 140 has a first sensor 142 and a second sensor 144. Each sensor 142, 144 is mounted on an isolation layer 146 and between two shield walls 148. Sensors 142, 144 are distant from one another in the horizontal direction and are also offset in the vertical direction as depicted in FIG. 9. The height (as seen in FIG. 9) of each sensor 142, 144 may be greater than the size (diameter) of a cell 108 and less than the row-to-row distanced in the cross-track direction. Sensor 142 may function as sensor 132 and sensor 144 may function as sensor 134.

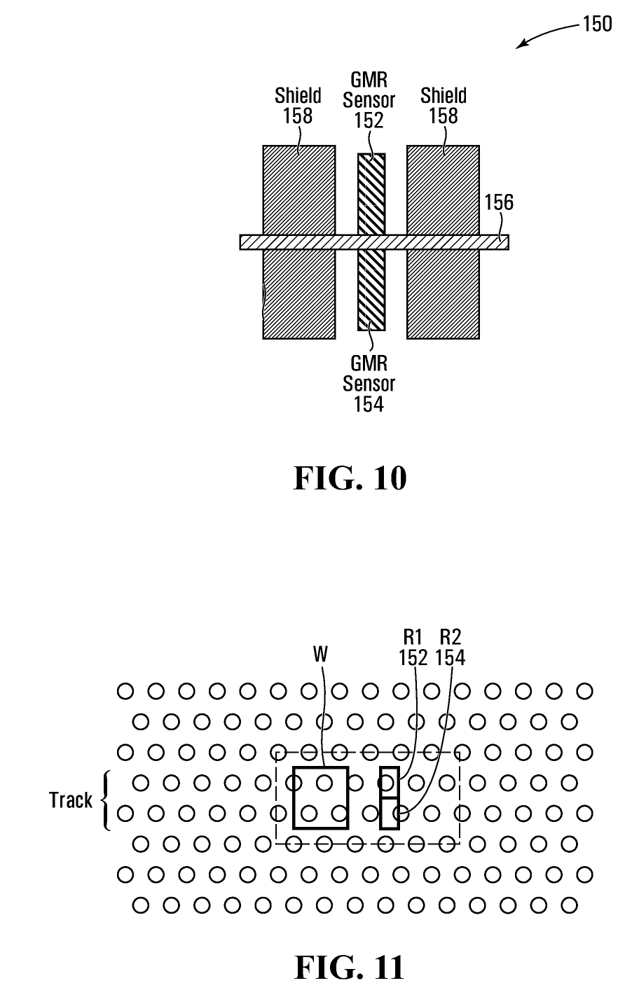

Of course, device 100 may be modified in alternative embodiments of the present invention. For example, an alternative read head 150 is illustrated in FIG. 10. In this arrangement, there is no horizontal offset between the two read sensors 152 and 154, which are mounted on opposite sides of an insulation layer 156. Each sensor 152 and 154 is shielded by shield walls 158.

FIG. 11 illustrates the operation of read head 150. As can be seen, there is no down-track offset between read sensors 152 and 154. Sensor 152 is positioned to read data from one row of cells in a track and sensor 154 is positioned to read data from another row of cells in the track.

As discussed above, a track may include more than two rows of cells, to provide increased down-track data resolution. With increased number of rows per track, the number of read sensors may be correspondingly increased so that each row of cells is read by a dedicated read sensor.

In the drawings, the physical cell size or bit length (BL) is depicted as being equal to about half of the bit pitch (Bp). The cross-track array pitch (Ap) is depicted as similar to Bp. The track pitch (Tp) is depicted as about twice of Ap. Cells (bit dots) are depicted as circular. The lattice pattern is shown as hexagonally close packed. These, and other depicted features, are shown for illustration purposes only and are not meant to be limiting. In actual embodiments, any of the above may be varied. For example, different BL/Bp, Ap/Bp, or Ap/Tp ratios may be used. Cells may be arranged in different lattice patterns.

While the same read sensors may be used for multiple functions, such as providing data sequence, timing information and PES, in some embodiments, a read sensor may be dedicated to a particular function and different sensors may be used to perform different functions.

The down-track distance between read head and write head may be increased to avoid read-while-write action. A DBPM disk may be DC magnetized for media pre-conditioning for reading bit position or timing.

In a specific embodiment, for a skew angle ranging from −15° to 15° and R/W spacing of about 10 um, the maximum read/write head offset in the cross-track direction may be 10×tan(15°)=2.7 um, corresponding to about 20 tracks (assuming Tp=125 nm).

When the cell-to-cell distance and row-to-row distance, or Bp and Ap, are uniform across the medium, the timing information for a particular track may be obtained from a neighboring track, as the cells in both tracks are arranged in the same pattern.

While a typical magnetic recording device is depicted in FIG. 1, the read head arrangements described herein can also be used in other types of recording devices or data storage devices for accessing or reading digital data from bit patterned media.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A method of recording and reading data, comprising;
providing a bit patterned medium comprising at least one track of bit cells, each of said bit cells settable to one of two distinct bit states, said track comprising at least two generally parallel rows of said bit cells, with bit cells in one of said two rows offset in a down track direction from bit cells in the other of said two rows,
positioning a write head over said track of bit cells, said write head spanning said two rows;
moving said track relative to said write head along said down track direction;
synchronously applying write signals to said write head to set the trailing bit cell covered by said write head, wherein the trailing bit cell covered by said write head alternates from being in one of said at least two rows to being in another of said least two rows as said track moves relative to said write head along said down track direction, and thereby write data to said track;
positioning a first read sensor over bit cells in one of said two rows and a second read sensor over bit cells in the other of said two rows to independently read said bit cells in said two rows as said track moves relative to said write head along said down track direction.

2. The method of claim 1, wherein said bit patterned medium is a discrete bit patterned medium.

3. The method of claim 1, wherein said bit patterned medium comprises bit cells forming a generally hexagonally close packed pattern.

4. The method of claim 1, wherein said at least two rows are generally concentric.

5. The method of claim 1, wherein said at least two rows are generally linear.

6. The method of claim 1, wherein said at least two rows consist of two rows of bit cells.

7. The method of claim 6, wherein said at least two rows comprise more than two rows, said method comprising positioning more than two read sensors to independently read bit cells in said more than two rows.

8. The method of claim 1, wherein said at least one track comprises a plurality of tracks.

9. The method of claim 1, wherein said write head simultaneously covers a plurality of said bit cells.

10. The method of claim 1, further comprising generating a synchronization clock signal from a read signal sensed by at least one of said read sensors, wherein said synchronously applying said write signal comprises synchronizing application of said write signal based on said synchronization clock signal.

11. The method of claim 1, further comprising
generating a position error signal from a read signal sensed by at least one of said read sensors, said position error signal indicative of a position of said write head relative to said track in a cross track direction; and
correcting positioning of said write head in said cross track direction based on said position error signal.

12. A recording device comprising:
a bit patterned medium comprising at least one track of bit cells, each of said bit cells settable to one of two distinct bit states, said track comprising at least two generally parallel rows of said bit cells, with bit cells in one of said two rows offset in a down track direction from bit cells in the other of said two rows;
a write head spanning said two rows of said bit cells;
a controller for synchronously applying write signals to said write head to set the trailing bit cell covered by said write head as said track moves relative to said write head, wherein the trailing bit cell covered by said write head alternates from being in one of said at least two rows to being in another of said at least two rows, and thereby write data to said track;
first and second read sensors each positioned to independently read bit cells in a respective one of said two rows, as said track moves relative to said write head along said down track direction.

13. The recording device of claim 12, wherein said bit patterned medium is a discrete bit patterned medium.

14. The recording device of claim 12, wherein said bit patterned medium comprises bit cells forming a generally hexagonally close packed pattern.

15. The recording device of claim 12, wherein said at least two rows are generally concentric.

16. The recording device of claim 12, wherein said at least two rows are generally linear.

17. The recording device of claim 12, wherein said at least two rows consist of two rows.

18. The recording device of claim 17, wherein said at least two rows comprise more than two rows, and said recoding device comprises more than two read sensors each for reading bit cells in one of said more than two rows.

19. The recording device of claim 12, wherein said at least one track comprises a plurality of tracks.

20. The recording device of claim 12, wherein said write head is configured and sized to simultaneously cover a plurality of said bit cells.

21. The recording device of claim 12, further comprising a processor for generating a synchronization clock signal from a read signal sensed by at least one of said read sensors, wherein said controller synchronizes application of said write signals to said write head based on said synchronization clock signal.

22. The recording device of claim 12, further comprising a processor for generating a position error signal from a read signal sensed by at least one of said read sensors, said position error signal indicative of a position of said write head relative to said track in a cross track direction, wherein said controller corrects positioning of said write head in said cross track direction based on said position error signal.
